(19) United States
(12) Patent Application Publication
(10) Pub. No.: US 2008/0192040 A1
(43) Pub. Date: Aug. 14, 2008

(54) PLASMA DISPLAY APPARATUS AND METHOD OF DRIVING THE SAME

(76) Inventor: Jeong-pil CHOI, Seoul (KR)

Correspondence Address: KED & ASSOCIATES, LLP, P.O. Box 221200, Chantilly, VA, 20153-1200, US

(21) Appl. No.: 12/028,998

(22) Filed: Feb. 11, 2008

(30) Foreign Application Priority Data
Feb. 12, 2007 (KR) 10-2007-0014490

(51) Int. Cl. G06F 3/038; G09G 3/28

(52) U.S. Cl. 345/211; 345/60

(57) ABSTRACT

A plasma display apparatus and a method of driving the same are disclosed. The plasma display apparatus includes a plasma display panel including an address electrode, and a data drive integrated circuit. The data drive integrated circuit receives a data voltage output by a data energy recovery circuit and a data bias voltage lower than the data voltage output by a low voltage bias circuit during an address period, and supplies a data signal having at least two voltage levels to the address electrode during the address period.

This application claims the benefit of Korean Patent Application No. 10-2007-0014490 filed on Feb. 12, 2007, which is hereby incorporated by reference.

### BACKGROUND

1. Field

An exemplary embodiment relates to a plasma display apparatus and a method of driving the same.

2. Description of the Background Art

A plasma display panel includes a phosphor layer inside discharge cells partitioned by barrier ribs and a plurality of electrodes used to supply driving signals to the discharge cells.

When driving signals are applied to the discharge cells of the plasma display panel, a discharge gas filled in the discharge cells generates vacuum ultraviolet rays, which thereby cause phosphors formed inside the discharge cells to emit light, thus displaying an image.

A high driving voltage required to drive the plasma display panel increases the power consumption. Further, the high driving voltage gives a load to a data drive integrated circuit (IC), and thus the reliability of the plasma display panel is reduced.

### SUMMARY

It is to be understood that both the foregoing general description and the following detailed description are exemplary and explanatory and are intended to provide further explanation of the invention as claimed.

An exemplary embodiment provides a plasma display apparatus capable of reducing the power consumption by lowering a driving voltage.

In one aspect, a plasma display apparatus comprises a plasma display panel including an address electrode, and a data drive integrated circuit that receives a data voltage output by a data energy recovery circuit and a data bias voltage lower than the data voltage output by a low voltage bias circuit during an address period, and supplies a data signal having at least two voltage levels to the address electrode during the address period.

In another aspect, a plasma display apparatus comprises a plasma display panel including an address electrode, a data energy recovery circuit that supplies or recovers an energy to or from the address electrode during an address period, and a data drive integrated circuit that receives a data voltage and a data bias voltage lower than the data voltage, which are output by the data energy recovery circuit, during the address period, and supplies a data signal having at least two voltage levels to the address electrode during the address period.

In yet another aspect, a method of driving a plasma display apparatus including an address electrode, the method comprises supplying a data voltage output by a data energy recovery circuit to the address electrode during an address period, supplying a data bias voltage lower than the data voltage output by a low voltage bias circuit to the address electrode during the address period, and receiving the data voltage and the data bias voltage to supply a data signal having at least two voltage levels to the address electrode.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 shows a configuration of a plasma display apparatus according to an exemplary embodiment;

FIG. 2 shows a structure of a plasma display panel according to the exemplary embodiment;

FIG. 3 illustrates an operation of the plasma display apparatus according to an exemplary embodiment;

FIGS. 4a and 4b show an implementation of a data drive integrated circuit (IC) of the plasma display apparatus and a timing diagram of switching operations of the data drive IC;

FIGS. 5a and 5b show another implementation of a data drive IC of the plasma display apparatus and a timing diagram of switching operations of the data drive IC;

FIG. 6 shows yet another implementation of a data drive IC of the plasma display apparatus; and

FIGS. 7a and 7b are diagrams for explaining a data energy recovery circuit and a low voltage bias circuit connected to a data drive IC of the plasma display apparatus.

### DETAILED DESCRIPTION

Reference will now be made in detail embodiments of the invention examples of which are illustrated in the accompanying drawings.

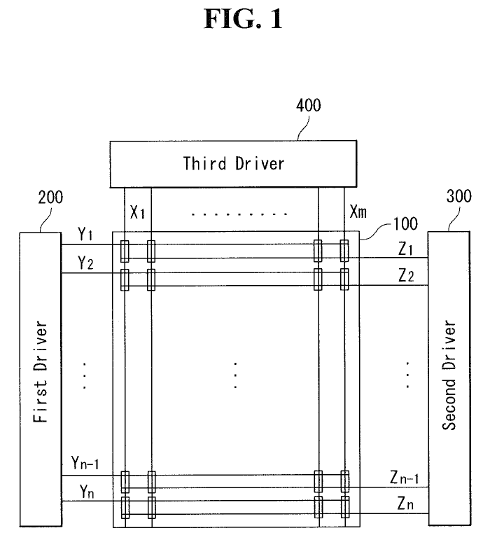

FIG. 1 shows a configuration of a plasma display apparatus according to an exemplary embodiment.

As shown in FIG. 1, the plasma display apparatus according to the exemplary embodiment includes a plasma display panel 100 including electrodes, a first driver 200, a second driver 300, and a third driver 400.

The plasma display panel 100 includes a front panel (not shown) and a rear panel (not shown) which coalesce with each other at a given distance. The plasma display panel 100 includes scan electrodes Y1 to Yn, sustain electrodes Z1 to Zn, and address electrodes X1 to Xm.

The first driver 200 supplies a reset signal to the scan electrodes Y1 to Yn during a reset period to thereby accumulate uniformly wall charges inside discharge cells. The first driver 200 supplies a scan signal to the scan electrodes Y1 to Yn during an address period to thereby select the discharge cells to be turned on. The first driver 200 supplies a sustain signal to the scan electrodes Y1 to Yn during a sustain period to thereby generate a sustain discharge inside the selected discharge cell.

The second driver 300 supplies a sustain bias signal to the sustain electrodes Z1 to Zn during a set-down period and the address period. The second driver 300 supplies a sustain signal to the sustain electrodes Z1 to Zn during the sustain period.

The third driver 400 receives data mapped for each subfield by a subfield mapping circuit (not shown) after being inverse-gamma corrected and error-diffused through an inverse gamma correction circuit (not shown) and an error diffusion circuit (not shown), or the like. The third driver 400 supplies a data signal corresponding to the scan signal to the address electrodes X1 to Xm in response to a data timing control signal received from a timing controller (not shown).

The third driver 400 includes a data drive integrated circuit (IC) for supplying a data signal to the address electrodes X1 to Xm during the address period. The data drive IC receives a data voltage output by a data energy recovery circuit and a data bias voltage lower than the data voltage output by a low voltage bias circuit. Hence, the data drive IC supplies a data signal having at least two voltage levels to the address electrodes X1 to Xm during the address period.

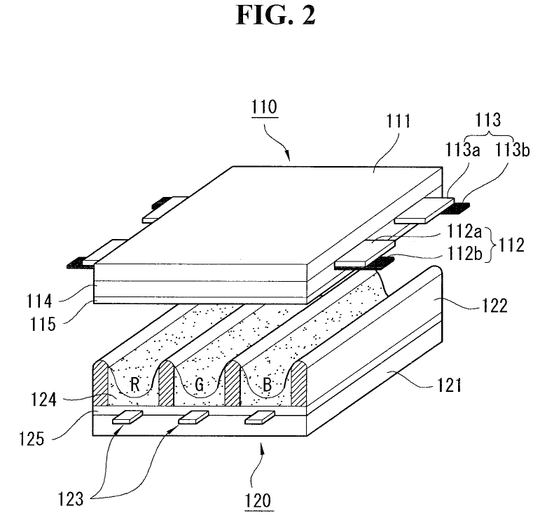

FIG. 2 shows a structure of a plasma display panel according to the exemplary embodiment.

As shown in FIG. 2, the plasma display panel 100 includes a front panel 110 and a rear panel 120 which coalesce with each other at a given distance therebetween. The front panel 110 includes a front substrate 111 on which a scan electrode 112 and a sustain electrode 113 are positioned parallel to each other. The rear panel 120 includes a rear substrate 121 on which an address electrode 123 is positioned to intersect the scan electrode 112 and the sustain electrode 113.

The scan electrode 112 and the sustain electrode 113 generate a mutual discharge therebetween in a discharge cell and maintain a discharge of the discharge cell.

The scan electrode 112 and the sustain electrode 113 each include transparent electrodes 112a and 113a made of a transparent material such as indium-tin-oxide (ITO) so as to emit light generated in the discharge cells to the outside, and bus electrodes 112b and 113b made of a metal material such as silver (Ag) so as to secure the driving efficiency.

An upper dielectric layer 114 covering the scan electrode 112 and the sustain electrode 113 is positioned on the front substrate 111 on which the scan electrode 112 and the sustain electrode 113 are positioned. The upper dielectric layer 114 limits discharge currents of the scan electrode 112 and the sustain electrode 113 and provides electrical insulation between the scan electrode 112 and the sustain electrode 113.

A protective layer 115 is positioned on an upper surface of the upper dielectric layer 114 to facilitate discharge conditions. The protective layer 115 may be formed of a material having a high secondary electron emission coefficient such as magnesium oxide (MgO).

The address electrode 123 positioned on the rear substrate 121 applies a data signal to the discharge cell.

A lower dielectric layer 125 covering the address electrode 123 is positioned on the rear substrate 121 on which the address electrode 123 is positioned.

Barrier ribs 122 are positioned on the lower dielectric layer 125 to partition the discharge cells. A phosphor 124 emitting visible light for an image display during an address discharge is positioned inside the discharge cells partitioned by the barrier ribs 122. The phosphor 124 may include red (R), green (G) and blue (B) phosphors.

Driving signals are applied to the scan electrode 112, the sustain electrode 113, and the address electrode 123 to generate a discharge inside the discharge cells of the plasma display panel. Hence, an image is displayed on the plasma display panel.

Since FIG. 2 has shown and described only an example of the plasma display panel applicable to the exemplary embodiment, the exemplary embodiment is not limited thereto.

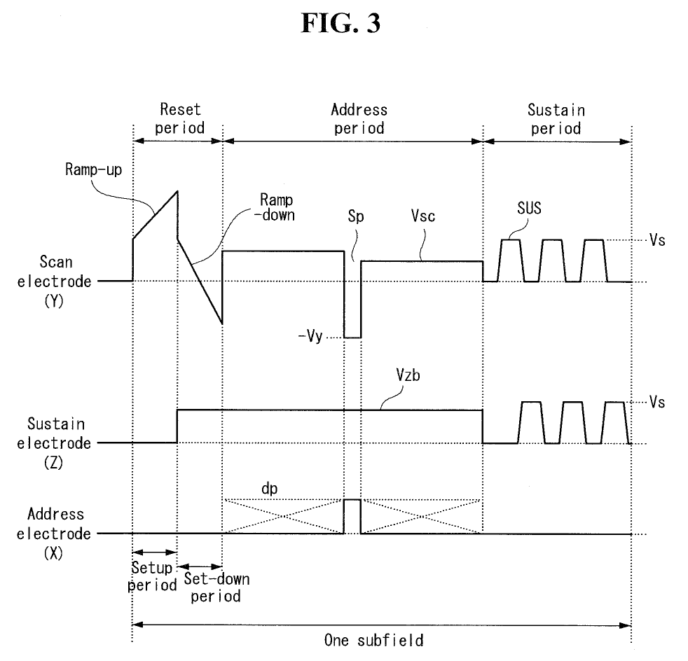

FIG. 3 illustrates an operation of the plasma display apparatus according to an exemplary embodiment.

As shown in FIG. 3, the first driver 200, the second driver 300, and the third driver 400 of FIG. 1 may supply driving signals to the scan electrode Y, the sustain electrode Z, and the address electrode X during at least one of a reset period, an address period, and a sustain period.

The first driver 200 may supply a reset rising signal Ramp-up to the scan electrode Y during a setup period of a reset period. The reset rising signal Ramp-up generates a weak dark discharge inside the discharge cells of the whole screen. Hence, wall charges of a positive polarity are accumulated on the sustain electrode Z and the address electrode X, and wall charges of a negative polarity are accumulated on the scan electrode Y.

The first driver 200 may supply a reset falling signal Ramp-down, which falls from a positive voltage level lower than a highest voltage of the reset rising signal Ramp-up to a given voltage level lower than a ground level voltage GND, to the scan electrode Y during a set-down period of the reset period, thereby generating a weak erase discharge inside the discharge cells. Hence, wall charges excessively accumulated inside the discharge cells are erased, and the remaining wall charges are uniformly distributed inside the discharge cells to the extent that an address discharge can stably occur.

The second driver 300 supplies a sustain bias voltage Vzb to the sustain electrode Z during the set-down period and an address period. The sustain bias voltage Vzb reduces a voltage difference between the scan electrode Y and the sustain electrode Z, thereby preventing the generation of an erroneous discharge.

A data driver included in the third driver 400 supplies a data signal dp of a positive polarity corresponding to a scan signal Sp of a negative polarity to the address electrode X.

The positive polarity data signal dp has at least two voltage levels using a data voltage output by a data energy recovery circuit and a data bias voltage lower than the data voltage output by a low voltage bias circuit.

A method of supplying the data signal dp having several voltage levels using voltages output by two constant voltage sources can cause lower power consumption than a method of supplying the data signal dp having one voltage level using a voltage output by one constant voltage source. Hence, a withstanding voltage of switches caused by a high voltage is minimized, and thus the heat generated in the switches can be reduced.

As a voltage difference between the scan signal Sp and the data signal dp is added to a wall voltage produced during the reset period, an address discharge occurs inside the discharge cells to which the data signal dp is applied. Wall charges are accumulated inside the discharge cells selected by performing the address discharge to the extent that when a sustain voltage Vs is applied, a discharge occurs.

During a sustain period following the address period, the first driver 200 and the second driver 300 supply sustain signals SUS to the scan electrode Y and the sustain electrode Z, respectively. As a wall voltage inside the discharge cells selected by performing the address discharge is added to the sustain signal SUS, every time the sustain signal SUS is applied, a sustain discharge occurs between the scan electrode Y and the sustain electrode Z.

An erase period during which the remaining wall charges after performing the sustain discharge are erased may be added after the sustain period. Further, a pre-reset period during which wall charges are stably distributed may be added prior to the reset period.

The data drive (IC) supplying the data signal during the address period will be described below in detail.

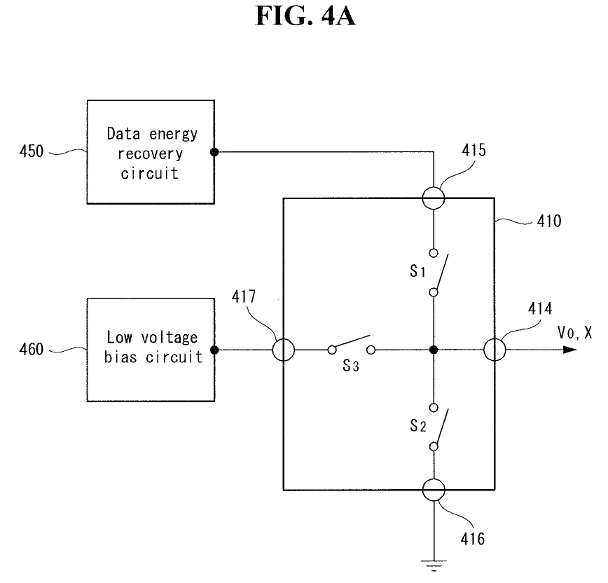

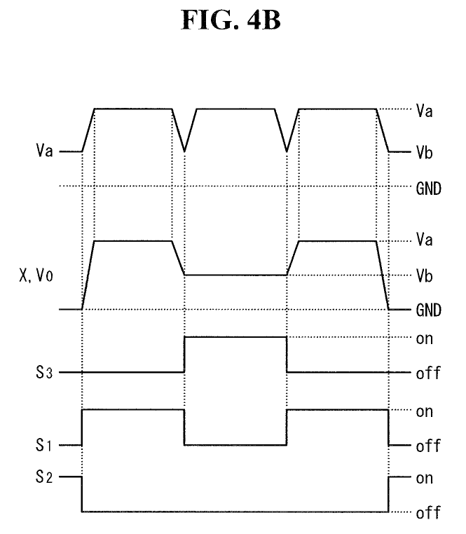

FIGS. 4a and 4b show an implementation of the data drive IC and a timing diagram of switching operations of the data drive IC.

As shown in FIG. 4A, a data drive IC 410 according to the exemplary embodiment supplies the data signal dp to the address electrode X during an address period. The data drive IC 410 receives a data voltage Va output by a data energy recovery circuit 450 and a data bias voltage Vb lower than the data voltage Va output by a low voltage bias circuit 460, and supplies the data signal dp having at least two voltage levels.

The data drive IC 410 includes a first switch S1, a second switch S2, and a third switch S3. The first switch S1 controls the supply of the data voltage Va to the address electrode X. The second switch S2 controls the supply of a ground level voltage GND output by a ground level voltage source to the address electrode X during the address period. The third switch S3 controls the supply of the data bias voltage Vb to the address electrode X.

Because the data drive IC 410 includes a plurality of switches (for example, the first, second, and third switches), the data drive IC 410 can receive the voltages output by the data energy recovery circuit 450, the ground level voltage source, and the low voltage bias circuit 460 through different paths by controlling switching operations of the first, second, and third switches S1, S2, and S3.

Accordingly, the data drive IC 410 can supply the data signal dp having the plurality of voltage levels to the address electrode X.

The first, second, and third switches S1, S2, and S3 are circuit elements capable of performing switching operations. The first, second, and third switches S1, S2, and S3 may be a field effect transistor (FET).

One terminal of the first switch S1 is electrically connected to the data energy recovery circuit 450, and the other terminal is electrically common-connected to one terminal of the second switch S2 and the address electrode X. The other terminal of the second switch S2 is electrically connected to the ground level voltage source. One terminal of the third switch S3 is electrically connected to the low voltage bias circuit 460, and the other terminal is electrically common-connected to the other terminal of the first switch, one terminal of the second switch S1, and the address electrode X.

The data drive IC 410 includes first to fourth terminals 414 to 417. The data drive IC 410 is electrically connected to the address electrode X through the first terminal 414, is electrically connected to the data energy recovery circuit 450 through the second terminal 415, is electrically connected to the ground level voltage source through the third terminal 416, and is electrically connected to the low voltage bias circuit 460 through the fourth terminal 417.

The data voltage Va may be supplied to the address electrode X though a path passing through the data energy recovery circuit 450, the second terminal 415, the first switch S1, and the first terminal 414. The data bias voltage Vb may be supplied to the address electrode X though a path passing through the low voltage bias circuit 460, the fourth terminal 417, the third switch S3, and the first terminal 414. The ground level voltage GND may be supplied to the address electrode X though a path passing through the ground level voltage source, the third terminal 416, the second switch S2, and the first terminal 414.

The data energy recovery circuit 450 supplies the data voltage Va, which is a highest voltage of the data signal dp, to the address electrode X. The data energy recovery circuit 450 may supply an energy rising up to the data voltage Va to the address electrode X, and may recover an reactive energy from the address electrode X and may store the reactive energy.

The low voltage bias circuit 460 supplies the data bias voltage Vb lower than the data signal dp to the address electrode X. The data bias voltage Vb may be higher than the ground level voltage GND and lower than the data voltage Va.

Therefore, while the data signal lies in a range between the ground level voltage and the data voltage in the related art, the data signal dp lies in a range between the data bias voltage Vb and the data voltage Va in the exemplary embodiment. Hence, a difference between the highest voltage and the lowest voltage of the data signal dp can be reduced.

A withstanding voltage of the switches can be reduced due to a reduction in the voltage difference, and thus heat generated in the data drive IC 410 during a drive of the plasma display panel can be reduced. The data bias voltage Vb is set at a minimum voltage that does not generate an erroneous discharge. When the data bias voltage Vb is one half of the data voltage Va, the withstanding voltage of the switches can be more effectively reduced.

As shown in FIG. 4B, the third driver 400 includes the data drive IC 410 supplying the data signal dp to the address electrode X during the address period. The data drive IC 410 receives the data voltage Va output by the data energy recovery circuit 450 and the data bias voltage Vb lower than the data voltage Va output by the low voltage bias circuit 460, and then supplies the data signal dp having at least two voltage levels to the address electrode X during the address period.

The first switch S1 is turned on. Hence, a voltage of the data signal dp output by the data drive IC 410 (i.e., an output voltage Vo of the data drive IC 410) rises from the ground level voltage GND to the data voltage Va. The first switch S1 remains in a turn-on state while the output voltage Vo of the data drive IC 410 is maintained at the data voltage Va.

The third switch S3 is turned on. Hence, the output voltage Vo falls from the data voltage Va to the data bias voltage Vb. On the other hand, in the related art, the voltage of the data signal was maintained at the data voltage Va for a predetermined period of time, and then fell from the data voltage Va to the ground level voltage GND.

The third switch S3 remains in a turn-on state while the output voltage Vo is maintained at the data bias voltage Vb. The address electrode X is connected to the data bias voltage Vb between the ground level voltage GND and the data voltage Va through the third switch S3.

Because the connection allows the output voltage Vo of the data drive IC 410 to operate between the data bias voltage Vb and the data voltage Va, a difference between the driving voltages can be reduced. The data bias voltage Vb is set at a minimum voltage that does not generate an erroneous discharge. Because the data drive IC 410 uses the data bias voltage Vb higher than the ground level voltage GND as a base voltage, the power consumption can be reduced.

Accordingly, the data energy recovery circuit 450 and the low voltage bias circuit 460 can supply the data signal dp capable of having the plurality of voltage levels to the address electrode X by repeating the above-described operations.

The second switch S2 is turned on at a time when the supply of the data signal dp starts and at a time when the supply of the data signal dp ends. When the second switch S2 is turned on, the first and third switches S1 and S3 are turned off.

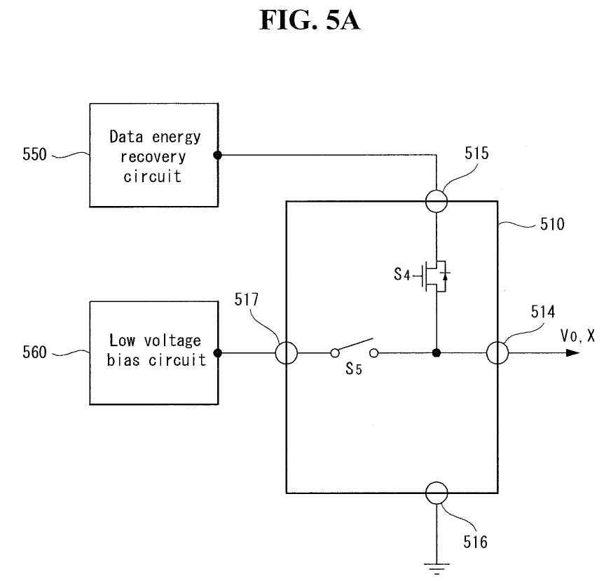

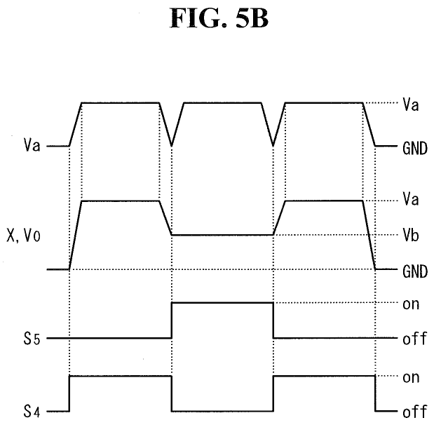

FIGS. 5a and 5b show another implementation of a data drive IC of the plasma display apparatus and a timing diagram of switching operations of the data drive IC.

As shown in FIG. 5A, a data drive IC 510 according to the exemplary embodiment supplies a data signal dp to the address electrode X during an address period.

The data drive IC 510 receives a data voltage Va output by a data energy recovery circuit 550 and a data bias voltage Vb lower than the data voltage Va output by a low voltage bias circuit 560, and thus the data signal dp may have at least two voltage levels.

The data drive IC 510 includes a fourth switch S4 and a fifth switch S5. The fourth switch S4 controls the supply of the data voltage Va or the ground level voltage GND to the address electrode X during the address period. The fifth switch S5 controls the supply of the data bias voltage Vb to the address electrode X during the address period.

Because the data drive IC 510 includes the plurality of switches (for example, the fourth and fifth switches), the data drive IC 510 can receive the voltages output by the data energy recovery circuit 550 and the low voltage bias circuit 560 through different paths by controlling switching operations of the fourth and fifth switches S4 and S5.

One terminal of the fourth switch S4 is electrically connected to the data energy recovery circuit 550, and the other terminal is electrically connected to the address electrode X. One terminal of the fifth switch 5S is electrically connected to the low voltage bias circuit 560, and the other terminal is electrically common-connected to the other terminal of the fourth switch S4 and the address electrode X.

Accordingly, the data drive IC 510 can supply the data signal dp having the plurality of voltage levels to the address electrode X.

The data drive IC 510 of FIG. 5A has a configuration in which the second switch S2 is removed from the data drive IC 410 of FIG. 4A.

Because an output voltage of the data drive IC 510 mostly lies in a range between the data bias voltage Vb and the data voltage Va, the second switch S2 electrically connected to the ground level voltage source supplying the ground level voltage GND may be removed. Therefore, an internal structure of the data drive IC 510 may need to have a function of a level shifter. A body diode of the fourth switch S4 of the data drive IC 510 can perform the function of the level shifter.

A ground level voltage switch (not shown) electrically connected to the ground level voltage source is turned on. Hence, the ground level voltage GND is output through the body diode of the fourth switch S4 and the data drive IC 510.

The fourth and fifth switches S4 and S5 are a circuit element capable of performing switch operations. The fourth and fifth switches S4 and S5 may be a field effect transistor (FET). It may be advantageous that the FET is used as a switching element.

The data drive IC 510 includes first to fourth terminals 514 to 517. The data drive IC 510 is electrically connected to the address electrode X through the first terminal 514, is electrically connected to the data energy recovery circuit 550 through the second terminal 515, is connected to a ground of the data drive IC 510 through the third terminal 516, and is electrically connected to the low voltage bias circuit 560 through the fourth terminal 517.

The data voltage Va and the ground level voltage GND may be supplied to the address electrode X though a path passing through the data energy recovery circuit 550, the second terminal 515, the fourth switch S4, and the first terminal 514. The data bias voltage Vb may be supplied to the address electrode X though a path passing through the low voltage bias circuit 560, the fourth terminal 517, the fifth switch S5, and the first terminal 514.

The data energy recovery circuit 550 supplies the data voltage Va and the ground level voltage GND to the address electrode X. When a ground level voltage switch electrically connected to the ground level voltage source is turned on, the ground level voltage GND is output from the data energy recovery circuit 550 to the data drive IC 510 through the body diode of the fourth switch S4.

The data energy recovery circuit 550 may supply an energy rising up to the data voltage Va to the address electrode X, and may recover an reactive energy from the address electrode X and may store the reactive energy.

Since the low voltage bias circuit 560 was described with reference to FIG. 4A, a description thereof is omitted.

As shown in FIG. 5B, the data drive IC 510 receives the data voltage Va and the data bias voltage Vb during the address period, and then supplies the data signal dp having at least two voltage levels to the address electrode X.

The fourth switch S4 is turned on. Hence, a voltage of the data signal dp output by the data drive IC 510 (i.e., an output voltage Vo of the data drive IC 510) rises from the ground level voltage GND to the data voltage Va. The fourth switch S4 remains in a turn-on state while the output voltage Vo of the data drive IC 510 is maintained at the data voltage Va.

The fifth switch S5 is turned on. Hence, the output voltage Vo falls from the data voltage Va to not the ground level voltage GND but the data bias voltage Vb.

The fifth switch S5 remains in a turn-on state while the output voltage Vo is maintained at the data bias voltage Vb. The address electrode X is connected to the data bias voltage Vb between the ground level voltage GND and the data voltage Va through the fifth switch S5.

Because the connection allows the output voltage Vo of the data drive IC 510 to operate between the data bias voltage Vb and the data voltage Va, a difference between the driving voltages can be reduced. Since effects capable of being obtained by a reduction in the difference between the driving voltages is substantially the same as the description with reference to FIG. 4B, a description of the effects are omitted in FIG. 5B. Since the number of switches in the data drive IC 510 of FIG. 5B is less than the number of switches in the data drive IC 410 of FIG. 4B, the manufacturing cost can be reduced.

Accordingly, the data energy recovery circuit 550 and the low voltage bias circuit 560 can supply the data signal dp capable of having the plurality of voltage levels to the address electrode X by repeating the above-described operations.

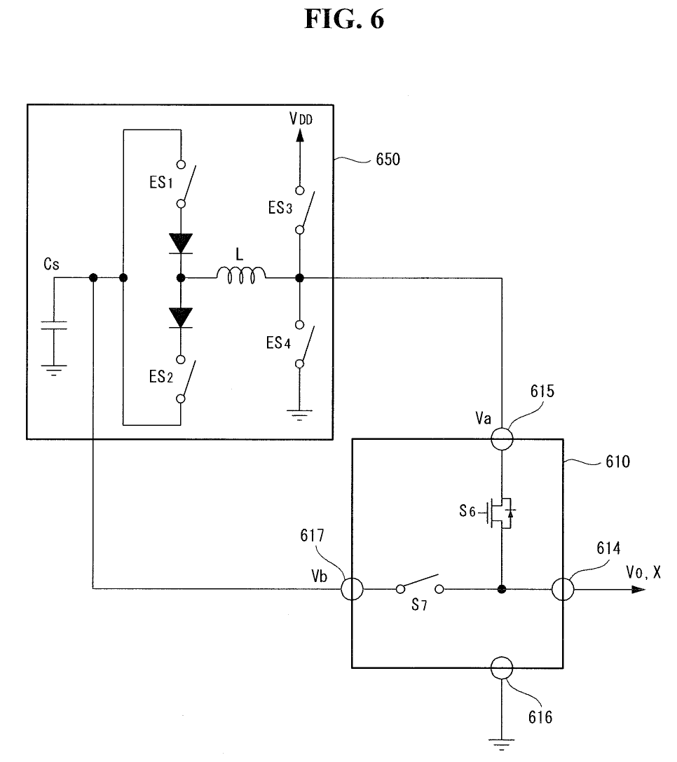

FIG. 6 shows yet another implementation of a data drive IC of the plasma display apparatus.

FIG. 6 shows a data energy recovery circuit 650 supplying or recovering an energy to or from the address electrode X during an address period, and a data drive IC 610 receiving a data voltage and a data bias voltage lower than the data voltage output by the data energy recovery circuit 650 during the address period to supply a data signal dp having at least two voltage levels to the address electrode X.

The data drive IC 610 includes a sixth switch S6 and a seventh switch S7. The data energy recovery circuit includes an energy storing unit Cs. One terminal of the sixth switch S6 is electrically connected to the data energy recovery circuit 650, and the other terminal is electrically connected to the address electrode X. One terminal of the seventh switch S7 is electrically connected to the energy storing unit Cs, and the other terminal is electrically common-connected to the other terminal of the sixth switch S6 and the address electrode X.

Description of structures and components identical or equivalent to those described with reference to FIGS. 4A and 5A are briefly made or are entirely omitted in FIG. 6.

The sixth and seventh switches S6 and S7 of FIG. 6 substantially have the same function as the fourth and fifth switches S4 and S5 of FIG. 5A, respectively.

A second terminal 615 and a fourth terminal 617 of the data drive IC 610 are electrically connected to the data energy recovery circuit 650.

Since a configuration of the data energy recovery circuit 650 is substantially the same as a configuration of the related art data energy recovery circuit and the configuration of the related art data energy recovery circuit is well known, a description of the data energy recovery circuit 650 is omitted in FIG. 6.

In case that the data energy recovery circuit 650 is used, a data bias constant voltage source is not necessary to form a data bias voltage Vb. It is advantageous that the data bias voltage Vb is substantially one half of a data voltage Va.

The energy storing unit Cs may be maintained at one half of the data voltage Va. Therefore, a voltage corresponding to one half of the data voltage Va can be used as the data bias voltage Vb. In case that the data energy recovery circuit 650 outputs the data voltage Va, an output voltage of the data drive IC 610 lies a ranges between one half of the data voltage Va and the data voltage Va. The data voltage Va may be approximately 60V.

Accordingly, the data drive IC 610 can supply the data signal dp having the data voltage Va and the data bias voltage Vb to the address electrode X by using the data energy recovery circuit 650. Since the low voltage bias circuit supplying the data bias voltage Vb can be removed, the manufacturing cost can be reduced. The power consumption of the plasma display panel can be greatly reduced by using a portion of a voltage recovered or supplied by the data energy recovery circuit 650.

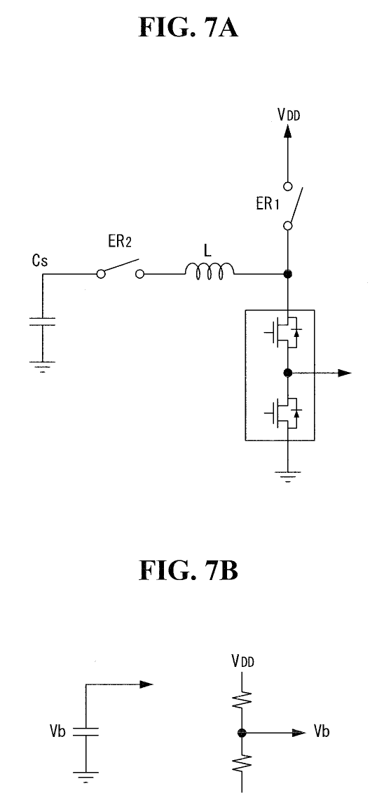

FIGS. 7a and 7b are diagrams for explaining a data energy recovery circuit and a low voltage bias circuit connected to a data drive IC of the plasma display apparatus.

As shown in FIG. 7A, the data drive IC according to the exemplary embodiment is connected to the data energy recovery circuit and the low voltage bias circuit to receive the data voltage, the data bias voltage, and the ground level voltage.

The data energy recovery circuit is not limited to the energy recovery circuit according to the exemplary embodiment. As shown in FIG. 7A, the data energy recovery circuit has basically a more effective configuration than the related art energy recovery circuit.

More specifically, since a value of an energy recovered by the energy storing unit Cs actively changes depending on changes in an output of the data drive IC, the data energy recovery circuit of FIG. 7A is more effective than the related art energy recovery circuit. The data energy recovery circuit of FIG. 7A may have a simple series configuration including the energy storing unit Cs, a second ER switch ER2, a resonance forming unit L, and the like. A location of the second ER switch ER2 and a location of the energy storing unit Cs may be exchanged for each other so as to improve the configuration effect. The data energy recovery circuit of FIG. 7A uses a driving method in which a source of the second ER switch ER2 generally using the FET is maintained at a ground level. The driving method is more stable than a floating method used in the related art energy recovery circuit.

FIG. 7B shows various examples of a supply circuit supplying the data bias voltage Vb. A separate data bias constant voltage source may be used to supply the data bias voltage Vb. However, a desired voltage can be obtained by dividing a data driving voltage using a resistor.

As described so far, since the plasma display apparatus according to the exemplary embodiment supplies the data signal having a plurality of voltage levels to the address electrode, the withstanding voltage of the switches can be minimized and heat generated in the switches can be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel including an address electrode; and
a data drive integrated circuit that receives a data voltage output by a data energy recovery circuit and a data bias voltage lower than the data voltage output by a low voltage bias circuit during an address period, and supplies a data signal having at least two voltage levels to the address electrode during the address period.

2. The plasma display apparatus of claim 1, wherein the data drive integrated circuit includes a first switch controlling the supply of the data voltage to the address electrode, a second switch controlling the supply of a ground level voltage output by a ground level voltage source to the address electrode, and a third switch controlling the supply of the data bias voltage to the address electrode.

3. The plasma display apparatus of claim 2, wherein the data bias voltage is higher than the ground level voltage and lower than the data voltage.

4. The plasma display apparatus of claim 3, wherein the data bias voltage substantially corresponds to one half of the data voltage.

5. The plasma display apparatus of claim 4, wherein one terminal of the first switch is electrically connected to the data energy recovery circuit, and the other terminal is electrically common-connected to one terminal of the second switch and the address electrode,
the other terminal of the second switch is electrically connected to the ground level voltage source, and
one terminal of the third switch is electrically connected to the low voltage bias circuit, and the other terminal is electrically common-connected to the other terminal of the first switch, one terminal of the second switch, and the address electrode.

6. The plasma display apparatus of claim 1, wherein the data drive integrated circuit includes a fourth switch controlling the supply of the data voltage to the address electrode, and a fifth switch controlling the supply of the data bias voltage to the address electrode.

7. The plasma display apparatus of claim 6, wherein one terminal of the fourth switch is electrically connected to the data energy recovery circuit, and the other terminal is electrically connected to the address electrode, and
one terminal of the fifth switch is electrically connected to the low voltage bias circuit, and the other terminal is electrically common-connected to the other terminal of the fourth switch and the address electrode.

8. A plasma display apparatus comprising:
a plasma display panel including an address electrode;
a data energy recovery circuit that supplies or recovers an energy to or from the address electrode during an address period; and
a data drive integrated circuit that receives a data voltage and a data bias voltage lower than the data voltage, which are output by the data energy recovery circuit, during the address period, and supplies a data signal having at least two voltage levels to the address electrode during the address period.

9. The plasma display apparatus of claim 8, wherein the data drive integrated circuit includes a sixth switch controlling the supply of the data voltage to the address electrode, and a seventh switch controlling the supply of the data bias voltage to the address electrode.

10. The plasma display apparatus of claim 8, wherein the data bias voltage substantially corresponds to one half of the data voltage.

11. The plasma display apparatus of claim 9, wherein the data energy recovery circuit includes an energy storing unit, and
one terminal of the sixth switch is electrically connected to the data energy recovery circuit, and the other terminal is electrically connected to the address electrode, and
one terminal of the seventh switch is electrically connected to the energy storing unit, and the other terminal is electrically common-connected to the other terminal of the sixth switch and the address electrode.

12. A method of driving a plasma display apparatus including an address electrode, the method comprising:
supplying a data voltage output by a data energy recovery circuit to the address electrode during an address period;
supplying a data bias voltage lower than the data voltage output by a low voltage bias circuit to the address electrode during the address period; and
receiving the data voltage and the data bias voltage to supply a data signal having at least two voltage levels to the address electrode during the address period.

13. The method of claim 12, wherein the supply of the data voltage to the address electrode is controlled by a first switch, the supply of a ground level voltage output by a ground level voltage source to the address electrode is controlled by a second switch, and the supply of the data bias voltage to the address electrode is controlled by a third switch.

14. The method of claim 13, wherein the data bias voltage is higher than the ground level voltage and lower than the data voltage.

15. The method of claim 14, wherein the data bias voltage substantially corresponds to one half of the data voltage.

16. The method of claim 13, wherein one terminal of the first switch is electrically connected to the data energy recovery circuit, and the other terminal is electrically common-connected to one terminal of the second switch and the address electrode,
the other terminal of the second switch is electrically connected to the ground level voltage source, and
one terminal of the third switch is electrically connected to the low voltage bias circuit, and the other terminal is electrically common-connected to the other terminal of the first switch, one terminal of the second switch, and the address electrode.

17. The method of claim 12, wherein the supply of the data voltage to the address electrode is controlled by a fourth switch, and the supply of the data bias voltage to the address electrode is controlled by a fifth switch.

18. The method of claim 17, wherein one terminal of the fourth switch is electrically connected to the data energy recovery circuit, and the other terminal is electrically connected to the address electrode, and
one terminal of the fifth switch is electrically connected to the low voltage bias circuit, and the other terminal is electrically common-connected to the other terminal of the fourth switch and the address electrode.

19. The method of claim 13, wherein the data energy recovery circuit includes an energy storing unit, and
the supply of the data voltage to the address electrode is controlled by a sixth switch, and the supply of the data bias voltage to the address electrode is controlled by a seventh switch.

20. The method of claim 19, wherein one terminal of the sixth switch is electrically connected to the data energy recovery circuit, and the other terminal is electrically connected to the address electrode, and
one terminal of the seventh switch is electrically connected to the energy storing unit, and the other terminal is electrically common-connected to the other terminal of the sixth switch and the address electrode.
